(19) United States
(12) Patent Application Publication
(10) Pub. No.: US 2006/0279493 A1
(43) Pub. Date: Dec. 14, 2006

(54) Electronic display panel

(75) Inventor: John W. Syrstad, Rutland, SD (US)

Correspondence Address: HUGH D JAEGER, 1000 SUPERIOR BLVD, SUITE 302, WAYZATA, MN, 553911873, US

(73) Assignee: Daktronics, Inc.

(21) Appl. No.: 11/227,599

(22) Filed: Sep. 15, 2005

Related U.S. Application Data
(63) Continuation-in-part of application No. 11/148,461, filed on Jun. 9, 2005.

(51) Int. Cl. G09G 3/32

(52) U.S. Cl. 345/82

(57) ABSTRACT

An electronic display panel having a combination of aligned and connected forwardly located panels to which a plurality of rearwardly located LED modules easily and readily secure using three-point attachment to form an electronic display panel suitable for accommodation by and for securing to the structure and framework of a sign system. Configured spacer brackets offer mutual spaced support between the front and rear panels and are constructed using arcuate geometry for dimension minimalizing to prevent interference with the viewing of the LED pixels. Notches are located along the bottom edge of the electronic display panel for simple engagement, such as with an arcuate surface of a pivot bar incorporated in a lower structure of a sign system.

### CROSS REFERENCES TO RELATED APPLICATIONS

This patent application is a continuation-in-part of Application Ser. No. 11/148,461 entitled “Sign System” filed on Jun. 09, 2005, which is pending.

### BACKGROUND OF THE INVENTION

1. Field of the Invention

The present invention is for an electronic display panel, and more particularly, pertains to a modularized electronic display panel easily and readily installed for use in a sign system.

2. Description of the Prior Art

Prior art electronic display panels have often been large expansive displays utilizing a continuous collection of front, mid and rear panels to achieve the wide breadths thereof. Such large and expansive panels are often cumbersome and difficult to handle because of physical size and weight. Also, they often present problems associated with changeout of components. In particular, if multiple LED panels and support structure were incorporated, a plurality of fastening hardware pieces had to be removed before any substitution of components could occur followed by reinstallation of the fastening hardware pieces after substitution of a new component. Other problems relate to maintaining a flat and planar well supported frontal viewing area over such an expansive viewing site. In the event that prior art electronic displays incorporated multiple panels across a large viewing area, the juxtaposing of individual display panels presented the problem of maintaining a continuous display without having undesirable spacing between the visually sensed LED pixels. The present invention provides an electronic display panel which overcomes these and many other shortcomings of the prior art.

### SUMMARY OF THE INVENTION

The general purpose of the present invention is to provide an electronic display panel for use in a sign system.

According to one embodiment of the present invention, there is provided an electronic display panel having a combination of aligned and connected forwardly located components and a plurality of rearwardly located LED (light emitting diode) modules easily and readily secured to the combination of aligned and connected forwardly located components. The major forwardly located components include in order from front to back a front panel, a seal, a polycarbonate panel, spacer brackets, and a rear panel and rearwardly located LED (light emitting diode) modules. The rearwardly located LED modules include an insertion panel having offset tabs and an opposed latch which readily engage the rear panel of the forwardly located components in three-point attachment. The geometry of the forwardly located components and the rearwardly located components is configured together or separately to offer minimum dimension structure where panels or edges of panels are mated and/or joined. Such dimension minimalizing allows uniform spacing of the LED pixels across each of the adjacent LED modules, as well as across adjoining forwardly located components. The spacer brackets are configured in a manner to offer mutual spaced support between the front and rear forwardly located panels and also are constructed for dimension minimalizing such that they will not interfere with the viewing of the LEDs. Notches are located along the bottom edge of the electronic display panel for simple engagement, such as with an arcuate surface of a pivot bar incorporated in the lower structure of a sign system. The geometry of the upper region of the electronic display panel is suitable for accommodation by and for securing to the upper structure of a sign system.

One significant aspect and feature of the present invention is an electronic display panel which can be easily and readily accommodated by and attached using minimal personnel to the frontal geometry of an electronic sign system.

Another significant aspect and feature of the present invention is an electronic display panel which is geometrically configured using close fitting design to provide a seamless LED display presentation having uniform LED spacing.

Another significant aspect and feature of the present invention is an electronic display panel having notched bottom structure for engagement with the lower structure of an electronic sign system.

Still another significant aspect and feature of the present invention is an electronic display panel having spacer brackets having recesses and which are joined as an assembly to maximize strength along and about the general structure while still allowing maximum viewing of LED pixels.

Yet another significant aspect and feature of the present invention is an electronic display panel having a rear panel featuring square viewing openings for the purpose of weight reduction and for providing access to the interior of the electronic display panel for cleaning of the interior of the electronic display panel.

A further significant aspect and feature of the present invention is the use of LED modules which simply and readily attach or detach from a rear panel.

A still further significant aspect and feature of the present invention is the use of LED modules having three-point attachment to the rear panel.

A still further significant aspect and feature of the present invention is an electronic display panel wherein individual LED modules include offset tabs which capturingly engage tab receptors of a rear panel and a rotatable latch which engages a latch receptor.

Having thus briefly described an embodiment of the present invention and having mentioned some significant aspects and features of the present invention, it is the principal object of the present invention to provide an electronic display panel.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is an isometric front view of an electronic display panel, the present invention;

FIG. 2 is an exploded isometric front view of the electronic display panel;

FIG. 3 is an exploded isometric rear view of the electronic display panel;

FIG. 4 is an isometric rear view of the front panel;

FIG. 5 is an isometric rear view of the rear panel;

FIG. 6 is a foreshortened isometric rear view of spacer bracket assemblies formed of suitably joined spacer brackets;

FIG. 7 is an exploded isometric rear view of an LED module including an insertion panel and an LED display panel;

FIG. 8 is an assembled isometric rear view of the LED module of FIG. 7;

FIG. 9 is a fragmentary view in cross section illustrating the relationship of an offset tab of the insertion panel with a tab receptor of the rear panel;

FIG. 10 is an exploded isometric rear view showing the rear panel distanced from the front panel and an LED module distanced from the rear panel;

FIG. 11 is an isometric view of an upper corner of the front panel of FIG. 10 showing the alignment of the upper region of a spacer bracket assembly to the upper region of the apertured planar section of the front panel incorporating the polycarbonate panel therebetween and of the upper region of the spacer bracket assembly to the upper region of the apertured planar section incorporating a spacer therebetween;

FIG. 12 is a cutaway isometric view of the electronic display panel with LED modules installed at the rear panel;

FIG. 13 is a rear view of the electronic display panel with LED modules installed thereupon and showing the relationship of the circular openings of the front panel to both the circular openings and the square openings of the rear panel;

FIG. 14 is a cross section view along line 14-14 of FIG. 13 showing the alignment of LEDs to circular openings of the insertion panel, to circular openings and a square opening, respectively, of the rear panel, and to circular openings of the front panel;

FIG. 15 is a fragmentary view in partial cross section along line 15-15 of FIG. 12 of an LED module during installation to the rear panel; and,

FIG. 16 is a view like FIG. 15 but shows the LED module fully maneuvered and pivoted into intimate contact with the rearwardly facing surface of the rear panel.

### DETAILED DESCRIPTION OF THE PREFERRED EMBODIMENT

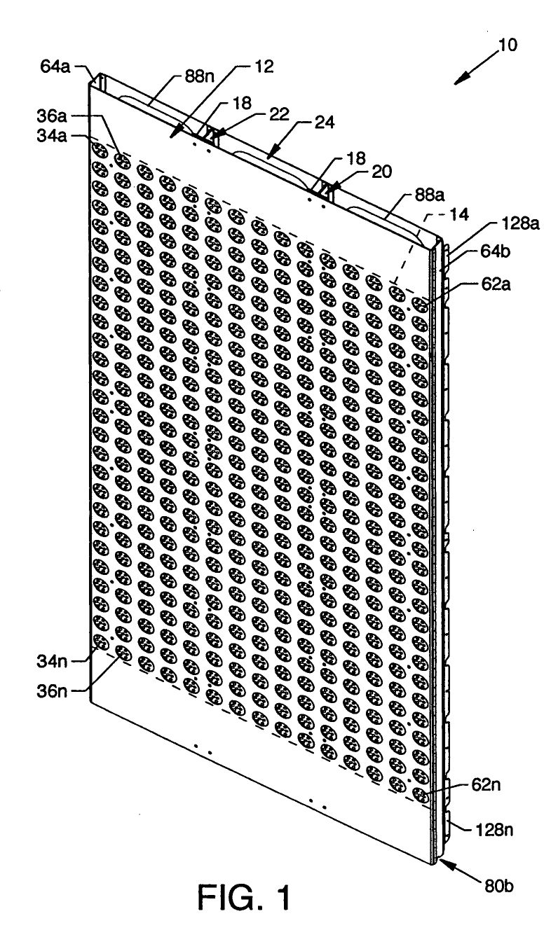

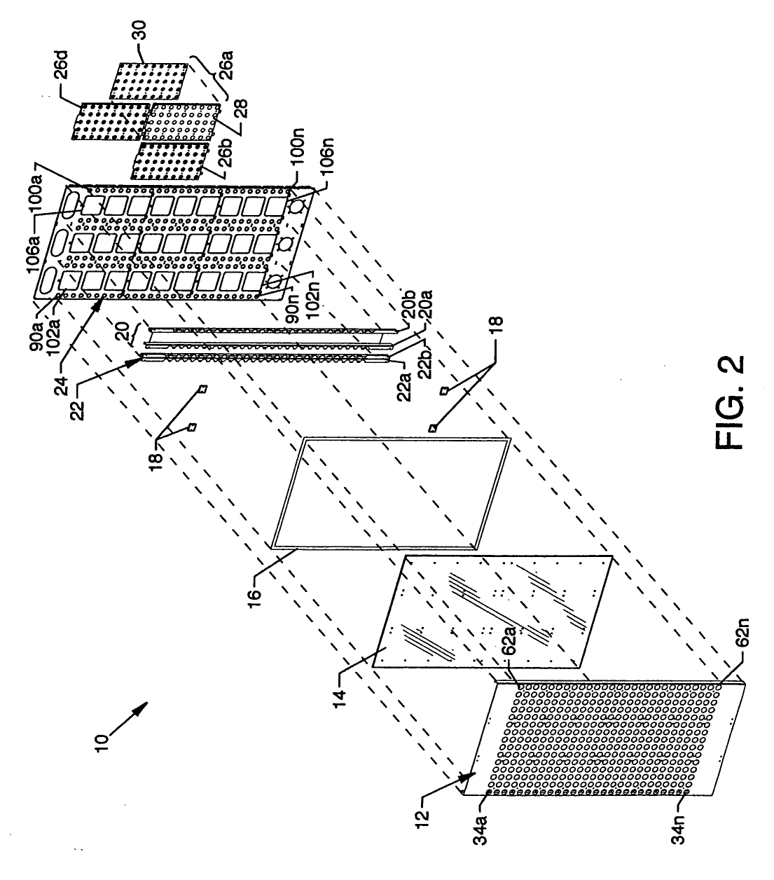

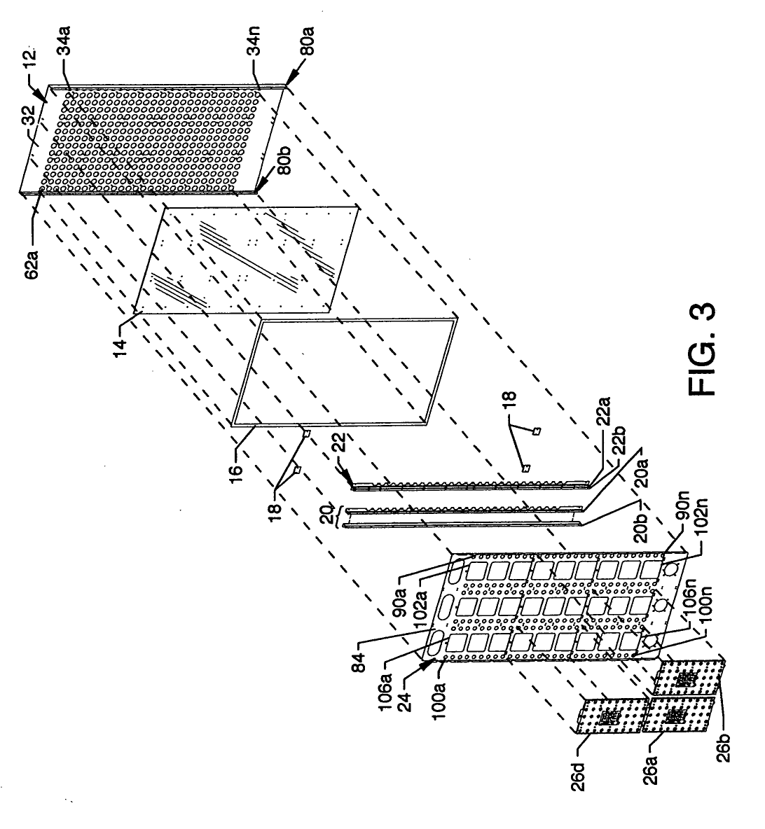

FIG. 1 is a an isometric front view of an electronic display panel 10, the present invention; FIG. 2 is an exploded isometric front view of the electronic display panel 10; and FIG. 3 is an exploded isometric rear view of the electronic display panel 10. With reference to the aforementioned figures, the electronic display panel 10 includes, from front to back, a front panel 12, a polycarbonate panel 14, a seal 16, a plurality of small spacers 18, vertically oriented spacer bracket assemblies 20 and 22 formed of suitably joined spacer brackets 20a and 20b and spacer brackets 22a and 22b, respectively, a rear panel 24, and a plurality of LED modules 26a-26n of which a small number are shown in FIG. 2. The LED module 26a is shown in exploded view to reveal an insertion panel 28 and an LED display panel 30.

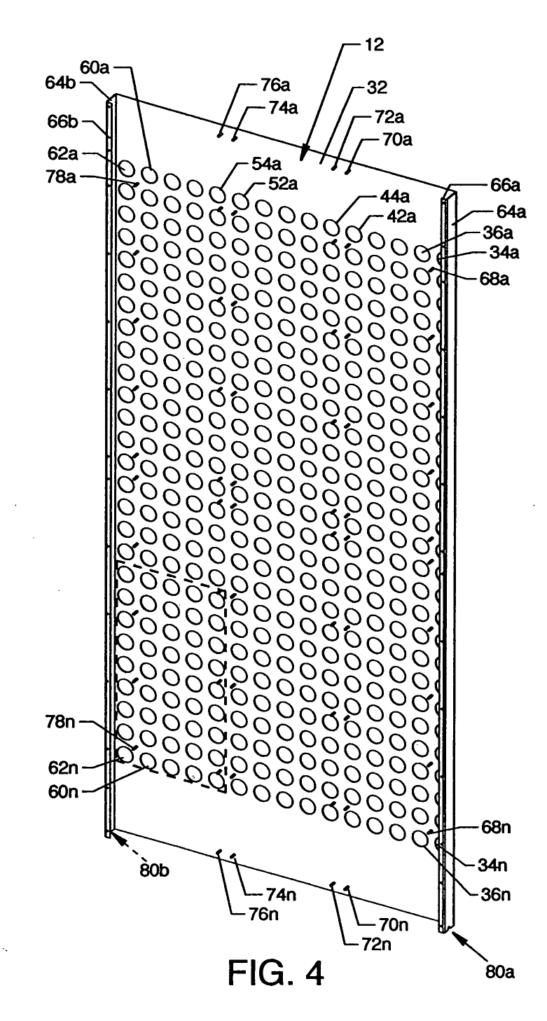

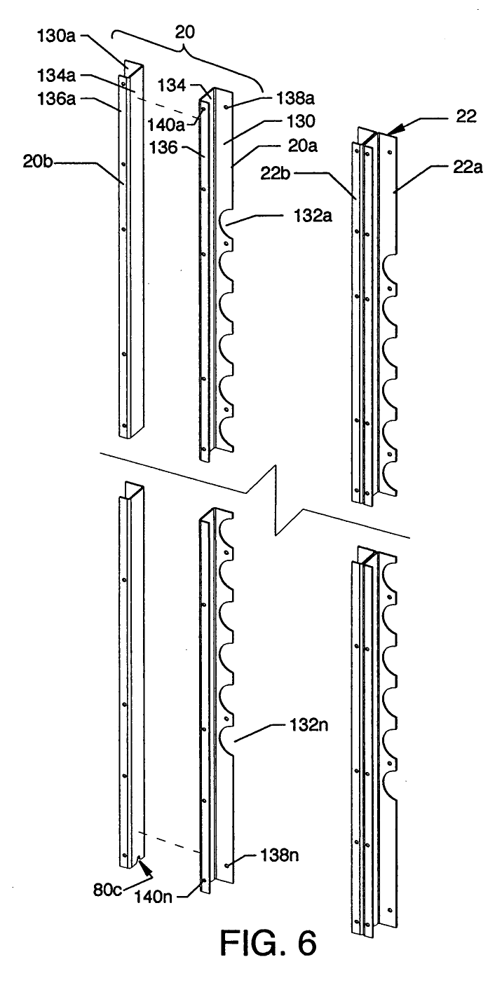

FIG. 4 is an isometric rear view of the front panel 12 including an apertured planar section 32 with a plurality of spaced circular openings 34a-34n. . . 62a-62n arranged in columns for viewing of light emitting diodes (LEDs) or other like devices, opposed edge panels 64a and 64b extending perpendicularly from the apertured planar section 32, and opposed apertured flanges 66a and 66b extending perpendicularly from the opposed edge panels 64a and 64b, respectively. The opposed edge panels 64a and 64b extending perpendicularly from the apertured planar section 32 and the opposed apertured flanges 66a and 66b extending perpendicularly from the opposed edge panels 64a and 64b provide spacing of the apertured planar section 32 with respect to the rear panel 24 in conjunction with the vertically oriented spacer bracket assemblies 20 and 22 which also contribute to structural integrity along, about, through, and within the electronic display panel 10. A plurality of studs 68a-68n and 78a-78n or other suitable fasteners arranged in columns extend rearwardly from the apertured planar section 32; and a plurality of studs 70a-70n, 72a-72n, 74a-74n and 76a-76n arranged in columns extend rearwardly from the apertured planar section 32 to accommodate corresponding mounting holes in the polycarbonate panel 14. The columns of studs 70a-70n, 72a-72n, 74a-74n and 76a-76n are also utilized for accommodation and mounting of the spacer bracket assemblies 20 and 22 and the plurality of spacers 18. Suitable fastener hardware is incorporated for use with the plurality of studs 68a-68n and 78a-78n and the plurality of studs 70a-70n, 72a-72n, 74a-74n and 76a-76n. Although reference is made to circular openings 34a-34n . . . 62a-62n, such openings could be of other shapes and/or sizes and shall not be deemed as limiting to the scope of the invention. Visibly incorporated at the lower portion of the edge panel 64a is a notch 80a for engagement of a pivot bar of an electronic sign bottom support channel (see application Ser. No. 11/148,461 entitled “Sign System” filed on Jun. 09, 2005, of which the present patent application is a continuation-in-part). Correspondingly, as also incorporated at the lower portion of the edge panel 64b, is a similarly shaped notch 80b for engagement of the pivot bar of an electronic sign bottom support channel. Similarly shaped notches are also included at the bottoms of the spacer brackets 20a, 20b, 22a and 22b comprising spacer bracket assemblies 20 and 22 in alignment with and having a function similar to the notches 80a and 80b, as described with reference to FIG. 6.

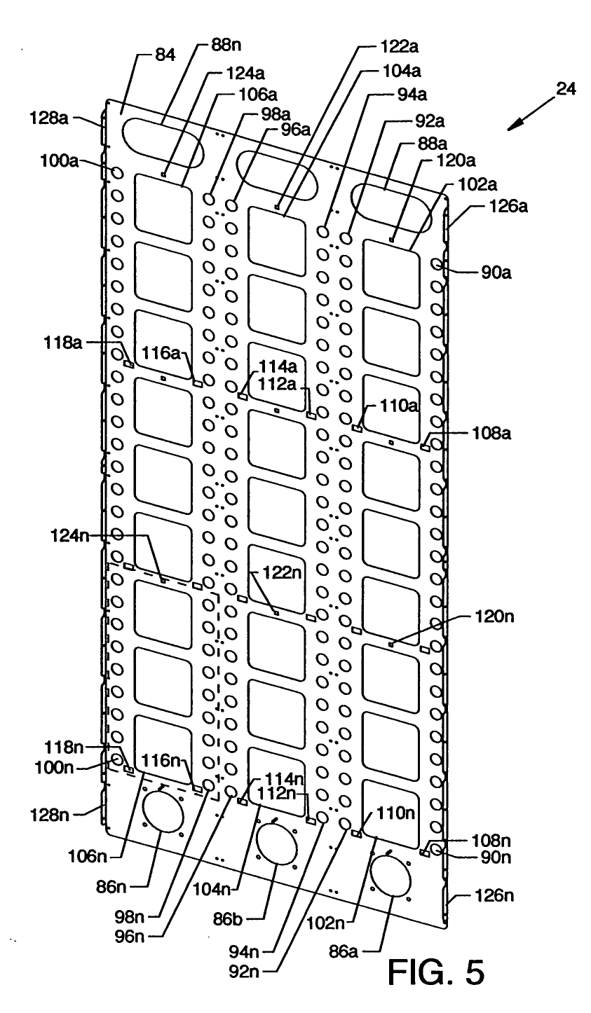

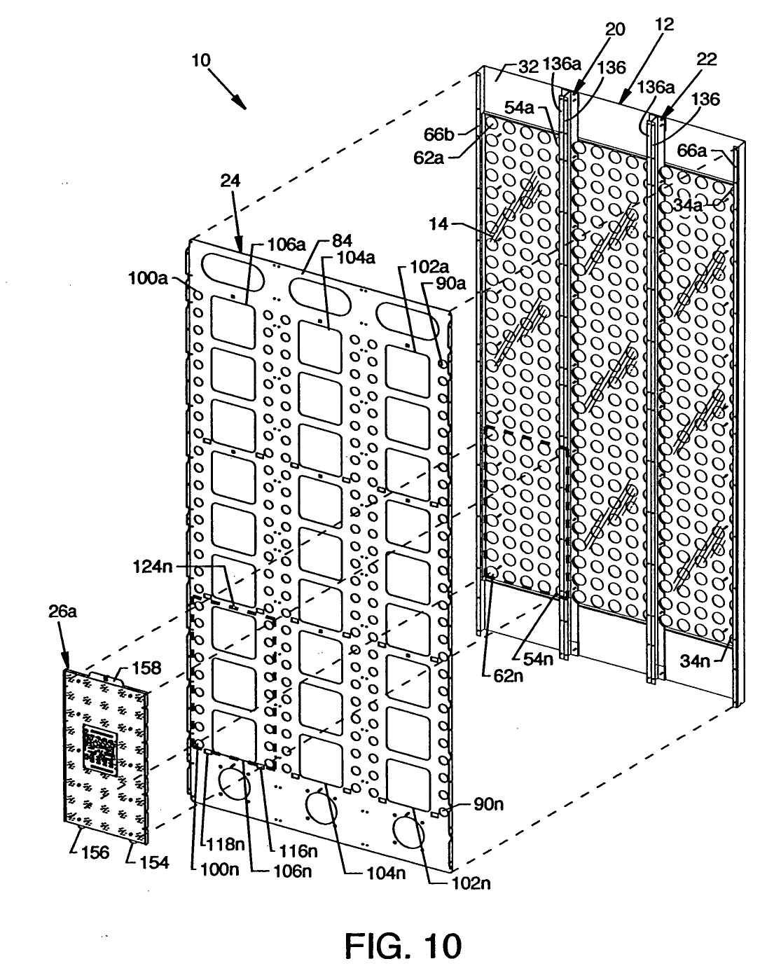

FIG. 5 is an isometric rear view of the rear panel 24 including an apertured planar section 84 with pluralities of various openings arranged in rows or columns. The apertured planar section 84 includes a plurality of inlet air openings 86a-86n in a row and a plurality of outlet air openings 88a-88n in a row located at the bottom portion and the top portion of the apertured planar section 84, respectively, for passage of fan cooling or heating air along and within the electronic display panel 10. The apertured planar section 84 of the rear panel 24 also includes columns of large or small openings which align to one or more, either singularly or collectively, of the plurality of circular openings 34a-34n. . . 62a-62n of the front panel 12 which are also arranged in columns. A plurality of circular openings 90a-90n, 92a-92n, 94a-94n, 96a-96n, 98a-98n and 100a-100n which generally are small with respect to a plurality of large substantially square openings 102a-102n, 104a-104n and 106a-106n, each arranged in columns, are arranged on the apertured planar section 84 as shown; i.e., the plurality of square openings 102a-102n are aligned between the plurality of circular openings 90a-90n and 92a-92n, the plurality of square openings 104a-104n are aligned between the plurality of circular openings 94a-94n and 96a-96n , and the plurality of square openings 106a-106n are aligned between the plurality of circular openings 98a-98n and 100a-100n. The large substantially square openings 102a-102n, 104a-104n and 106a-106n include rounded corners each having a radius directly relating to the radius of each of the circular openings 90a-90n, 92a-92n, 94a-94n, 96a-96n, 98a-98n and 100a-100n wherein such radii can be equal but are not required to be equal. The relationship of the radii of the plurality of circular openings 90a-90n, 92a-92n, 94a-94n, 96a-96n, 98a-98n and 100a-100n and of the rounded corners of the plurality of square openings 102a-102n, 104a-104n and 106a-106n is such that the radii of the plurality of circular openings 90a-90n, 92a-92n, 94a-94n, 96a-96n, 98a-98n and 100a-100n and of the rounded corners of the plurality of square openings 102a-102n, 104a-104n and 106a-106n are slightly less than the radii of the plurality of spaced circular openings 34a-34n 62a-62n of the front panel 12 in order that viewing of the pixels of the LEDs in the LED modules 26a-26n from the side is not impaired. A plurality of tab receptors 108a-108n, 110a-110n, 112a-112n, 114a-114n, 116a-116n and 118a-118n arranged in intervals in columns and opposingly located near the lower corners of various square openings 102a-102n, 104a-104n and 106a-106n are included as shown. A plurality of latch receptors 120a-120n, 122a-122n and 124a-124n arranged in intervals in columns and located near the upper edge of various square openings 102a-102n, 104a-104n and 106a-106n are included as shown. Portions of the described columnar square openings 102a-102n, 104a-104n and 106a-106n, circular openings 90a-90n, 92a-92n, 94a-94n, 96a-96n, 98a-98n and 100a-100n, latch receptors 120a-120n, 122a-122n and 124a-124n, and tab receptors 108a-108n, 100a-100n, 112a-112n, 114a-114n, 116a-116n and 118a-118n can be utilized as a group to aligningly and directly and by intimate contact receive structure of and to otherwise interface and secure with and to one or more of the LED modules 26a-26n. For the purpose of example and illustration, one such group, such as shown in the lower left corner of the rear panel 24, is delineated by a dashed rectangle to include the bottom three square openings of the square openings 106a-106n, the bottom nine circular openings of the circular openings 100a-100n, the bottom nine circular openings of the circular openings 98a-98n, the bottom tab receptors 116n and 118n of the tab receptors 116a-116n and 118a-118n, and the bottom single latch receptor 124n of the latch receptors 124a-124n. Alignment of such openings carries through in indirect and distanced alignment with the nine lower corresponding circular openings in the circular opening columns 54a-54n . . . 62a-62n of the front panel 12, such as shown in FIG. 10. The number of included features in a group could be more or less than just described depending on the requirement and size of the LED modules 26a-26n or the overall requirement and size of the electronic display panel 10. Although reference is made to circular openings 90a-90n, 92a-92n, 94a-94n, 96a-96n, 98a-98n and 100a-100n and to square openings 102a-102n, 104a-104n and 106a-106n , such openings could be of other shapes and/or sizes and shall not be deemed as limiting to the scope of the invention. A plurality of opposed apertured connection tabs 126a-126n and apertured connection tabs 128a-128n extend perpendicularly and rearwardly from the apertured planar section 84 and are appropriately spaced in close proximity to the circular openings 90a-90n and 100a-100n to preserve constant LED pixel spacing. The apertured connection tabs 126a-126n and 128a-128n of adjacent electronic display panels 10 are incorporated to mutually secure, with the inclusion of optional weatherstrip seals, adjacent electronic display panels 10 with the aid of suitable fasteners.

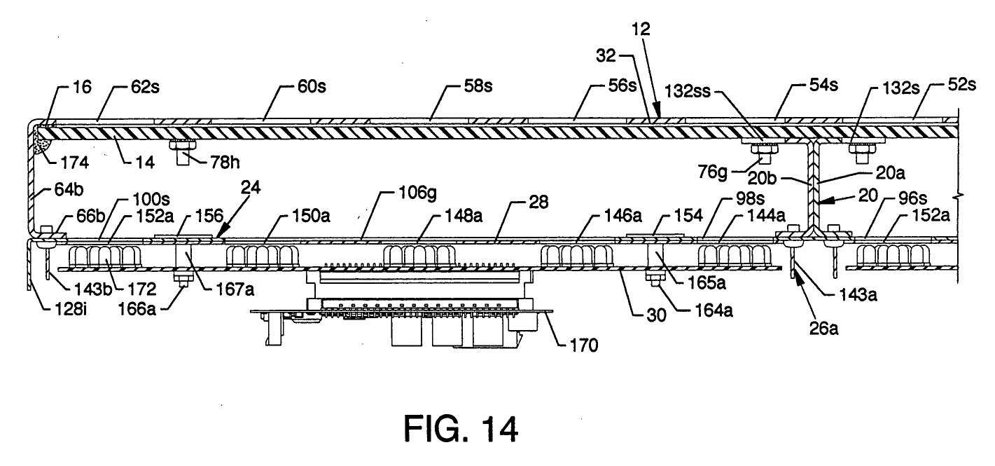

FIG. 6 is a foreshortened isometric rear view of the spacer bracket assemblies 20 and 22 formed of spacer brackets 20a and 20b (shown separated) and suitably joined spacer brackets 22a and 22b, respectively. Spacer bracket 20a includes a panel 130 interrupted along one edge by a plurality of arcuate recesses 132a-132n the radius of each of which corresponds to the radius of each of the circular openings of the column of circular openings 52a-52n of the front panel 12. A panel 134 extends perpendicularly from the other edge of the panel 130. Another panel 136 extends perpendicularly from the panel 134 in the same direction as panel 130, the rearwardly facing surface of which serves as a mounting surface in the same plane as the rearwardly facing surfaces of the apertured flanges 66a and 66b of the front panel 12 for accommodation and mating of the rear panel 24 thereto. A plurality of suitably located holes 138a-138n are included along the panel 130 of the spacer bracket 20a for accommodation of the studs 74a-74n extending rearwardly from the front panel 12 and through holes in the polycarbonate panel 14. A plurality of suitably located holes 140a-140n in the panel 136 are included for mounting the spacer bracket 20a to the rear panel 24 using suitable fasteners. The spacer bracket 20a aligns to the rear of the polycarbonate panel 14 and to the circular openings of the column of circular openings 52a-52n of the front panel 12 and in close proximity to the column of circular openings 96a-96n of the rear panel 24. Spacer bracket 20b is a mirror image of spacer bracket 20a and has the same features as spacer bracket 20a, some of which are referenced, including a panel 130a, arcuate recesses 132aa-132nn, of which arcuate recess 132ss is shown in FIG. 14, a panel 134a and a panel 136a corresponding, respectively, to panel 130, arcuate recesses 132a-132n, panel 134 and panel 136 of the spacer bracket 20a. Spacer bracket 20b aligns in corresponding and reverse fashion with the circular openings of the column of circular openings 54a-54n of the front panel 12 and in near proximity to the column of circular openings 98a-98n of the rear panel 24 in corresponding alignment thereto. The panels 134 and 134a of the spacer brackets 20a and 20b, respectively, are suitably joined to form a lamination to foster structural integrity.

The structure of the spacer bracket assembly 22 is identical in design and function to that of the spacer bracket assembly 20. The spacer bracket assembly 22 aligns to the rear of the polycarbonate panel 14 and to the circular openings of the columns of circular openings 42a-42n and 44a-44n of the front panel 12 and in close proximity to the columns of circular openings 92a-92n and 94a-94n of the rear panel 24. Also shown is a notch 80c at the bottom of the spacer bracket 20b. Each of the spacer brackets 20a, 22a and 22b has a similarly constructed notch.

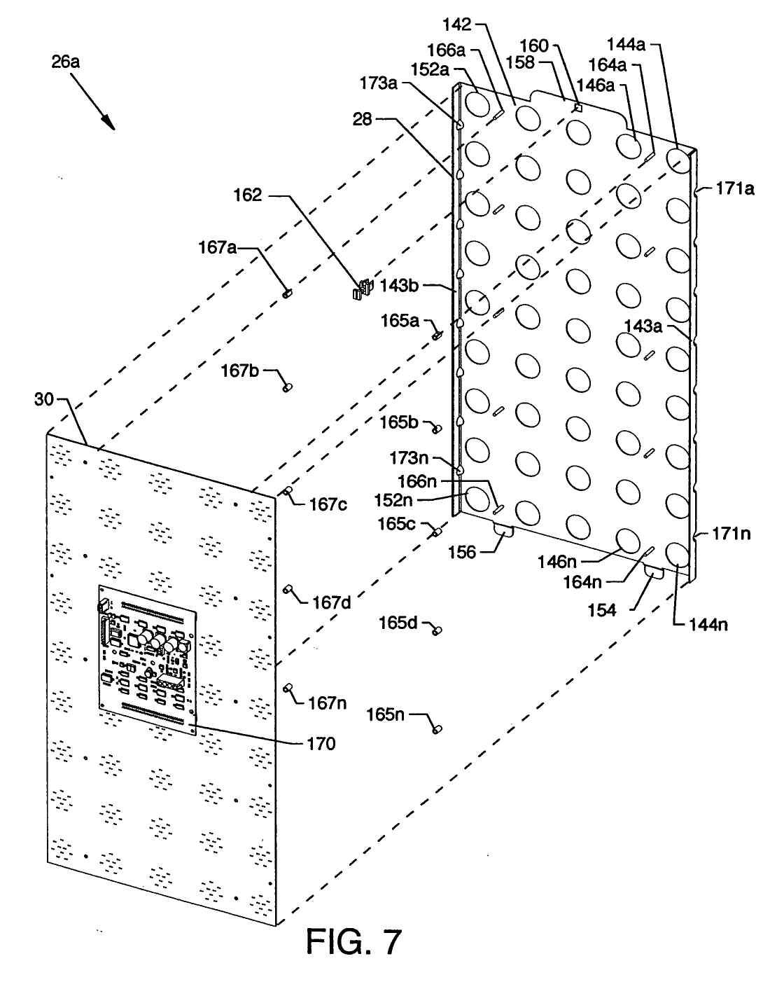

FIG. 7 is an exploded isometric rear view of the LED module 26a of the plurality of LED modules 26a-26n including the insertion panel 28 and the LED display panel 30 which secures to the insertion panel 28. The insertion panel 28 includes an apertured planar section 142 including planar edge panels 143a and 143b extending perpendicularly therefrom. The apertured planar section 142 has a plurality of spaced circular openings 144a-144n . . . 152a-152n arranged in columns to align with LEDs on the forward side of the LED display panel 30, as well as to align to the appropriate circular openings 90a-90n, 92a-92n, 94a-94n, 96a-96n, 98a-98n and 100a-100n and the square openings 102a-102n, 104a-104n and 106a-106n of the rear panel 24. Offset tabs 154 and 156 offset from the plane of the apertured planar section 142 extend from the lower region of the apertured planar section 142 for insertion into and accommodation such as, for example and illustration, by the lowermost tab receptors 116n and 118n of the pluralities of tab receptors 116a-116n and 118a-118n shown in FIG. 5. A planar tab 158 including a latch mount hole 160 extends upwardly from and along the plane of the apertured planar section 142. A rotatable latch 162 installs in the latch mount hole 160 to be further accommodated by, for example and demonstration, the lowermost latch receptor 124n of the plurality of latch receptors 124a-124n. A plurality of studs 164a-164n and 166a-166n arranged in columns, including fastener nuts (not shown), extend rearwardly from the apertured planar section 142 to accommodate a plurality of spacers 165a-165n and 167a-167n located between the insertion panel 28 and the LED display panel 30. An electronics circuit board 170 is also included on the rear of the LED display panel 30. A plurality of cutouts 171a-171n are located at the junction of the planar edge panel 143a and the apertured planar section 142 and a plurality of cutouts 173a-173n are located at the junction of the planar edge panel 143b and the apertured planar section 142 to accommodate the heads of the rivets (not shown) or other fasteners which fasten the apertured planar section 84 of the rear panel 24 to the apertured flanges 66a and 66b of the front panel 12 and which accommodate the heads of the rivets (not shown) or other fasteners which fasten the rear panel 24 to the holes, such as holes 140a-140n, of the spacer bracket assemblies 20 and 22.

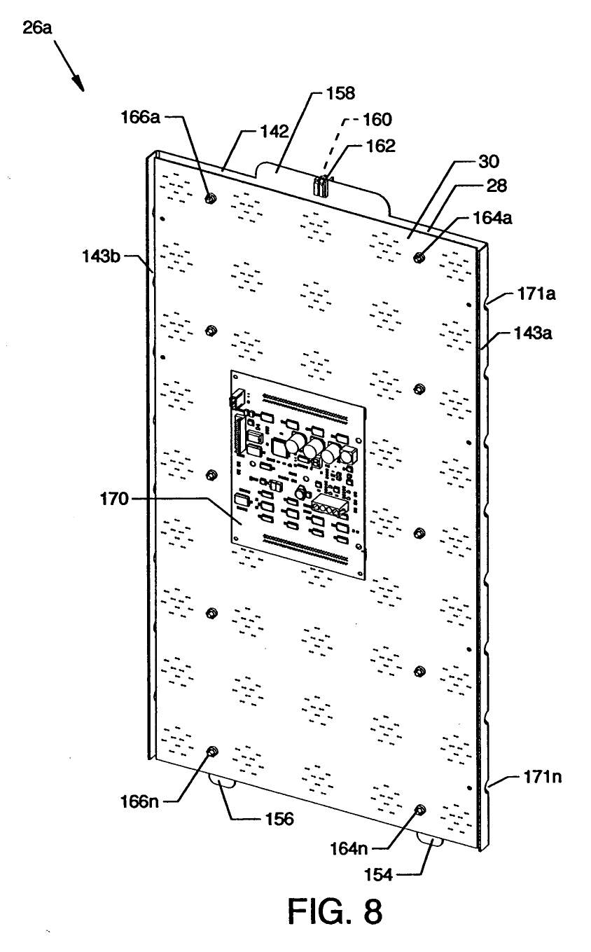

FIG. 8 is an assembled isometric rear view of the LED module 26a, which is typical of the plurality of LED modules 26a-26n.

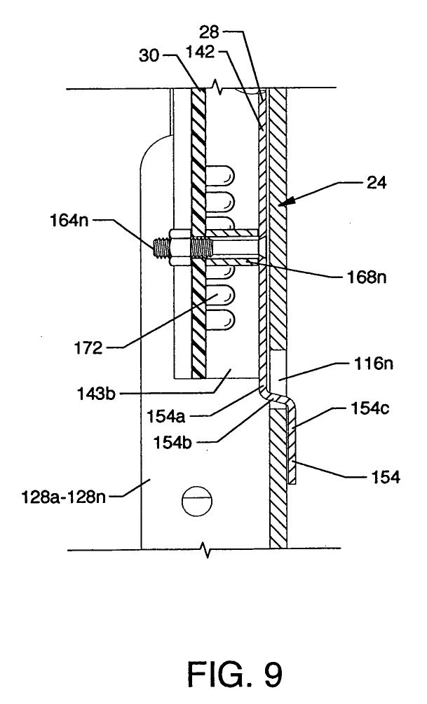

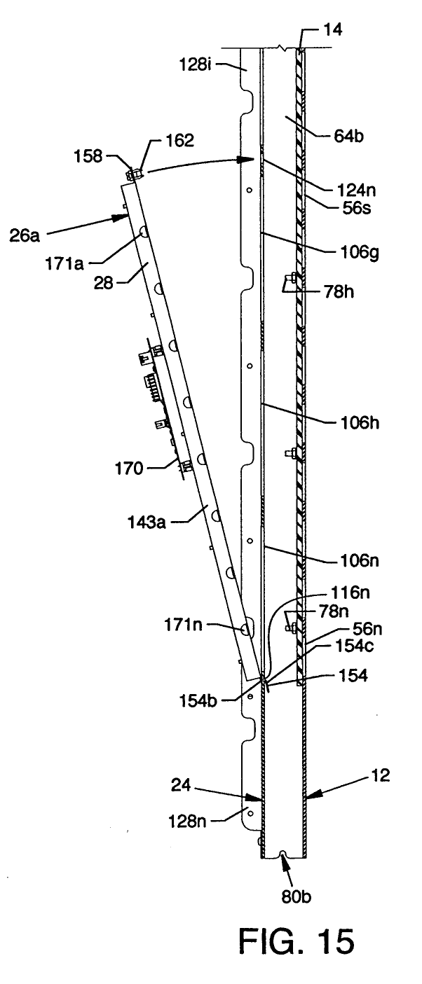

FIG. 9 is a fragmentary view in cross section illustrating the relationship of the offset tab 154 of the insertion panel 28 with the tab receptor 116n of the rear panel 24. The offset tab 154 includes a vertically oriented portion 154a extending downwardly from the main body of the apertured planar section 142, an angled portion 154b extending downwardly and forwardly from the vertically oriented portion 154a, and a downwardly directed vertically oriented portion 154c extending from the angled portion 154b. The downwardly directed vertically oriented portion 154c is first introduced into the tab receptor 116n at an angle and urged therethrough followed by further urging to introduce the angled portion 154b into the tab receptor 116n for alignment therein followed by pivoting of the LED module 26a, such as indicated by the arrow in FIG. 15, to complete capture of the offset tab 154 by the tab receptor 116n. The offset tab 156 includes similar features and is utilized in the same way. Also shown are a plurality of LEDs 172 secured to the LED display panel 30 in close juxtaposition with the rear of rear panel 24.

FIG. 10 is an exploded isometric rear view showing the rear panel 24 distanced from the front panel 12 and the LED module 26a distanced from the rear panel 24. The general alignment of the LED module 26a directly to the rear panel 24 and indirectly to the front panel .12 and to the suitable circular openings and square openings of the front and rear panels 12 and 24, respectively, is shown by dashed lines on the front panel 12 and the rear panel 24 and by dashed lines between the LED module 26a, the rear panel 24, and the front panel 12, as described previously with reference to FIGS. 4 and 5. The alignment of the remainder of the LED panels 26b-26n in a similar fashion can occur at adjacent locations. Shown in particular are the spacer bracket assemblies 20 and 22 suitably secured to the rear side of the front panel 12 by the plurality of studs 70a-70n, 72a-72n, 74a-74n and 76a-76n . The rear panels 136 and 136a (FIG. 6) of the spacer bracket assemblies 20 and 22 and the rearwardly located apertured flanges 66a and 66b of the front panel 12 align in a common plane to present a suitable mounting surface for intimate placement and securing of the apertured planar section 84 of the rear panel 24 thereto.

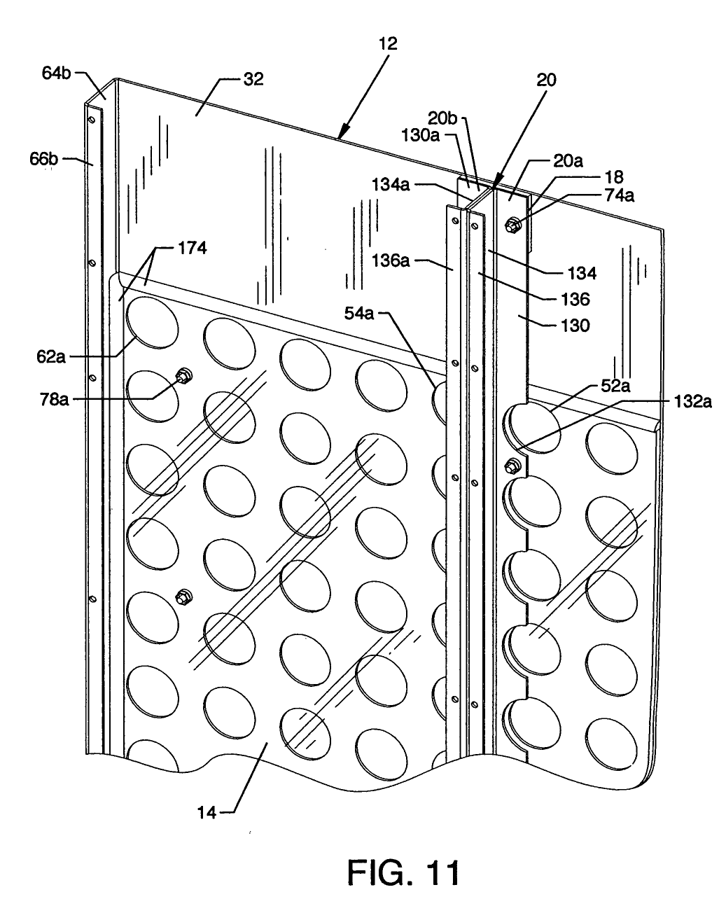

FIG. 11 is an isometric view of an upper corner of the front panel 12 showing the alignment of the upper region of the spacer bracket assembly 20 to the upper region of the apertured planar section 32 of the front panel 12 incorporating the polycarbonate panel 14 therebetween and of the upper region of the spacer bracket assembly 20 to the upper region of the apertured planar section 42 incorporating a spacer 18 therebetween. The geometrical aspects of the components of the spacer bracket assembly 20 are configured to present a minimum structural profile while still providing structural integrity and suitable viewability of the LED pixels. The spacer brackets 20a and 20b, being of channel construction, are suitably joined unitarily back to back forming a laminated spacer bracket assembly 20 to offer combined and enhanced structural integrity for use in the electronic display panel 12, while the arcuate recesses 132a-132n in the panels 130 and 130a unrestrictively allow suitable viewing of the LEDs 172 through the circular openings 34a-34n 62a-62n of the front panel 12. Adhesive 174 is incorporated, such as shown, to seal the edges of the polycarbonate panel 14 to the rearwardly facing surface of the apertured planar section 32 and to the edge panels 64a-64b.

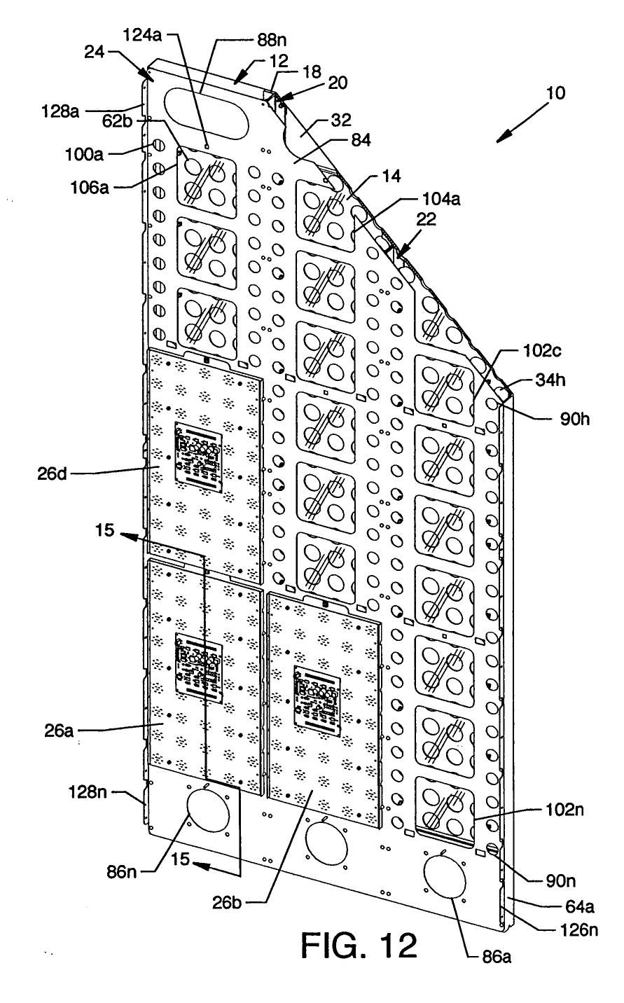

FIG. 12 is a cutaway isometric view of the electronic display panel 10 with LED modules 26a, 26b and 26d installed at the rear panel 24. Also shown is the relationship of the rear panel 24 to the front panel 12.

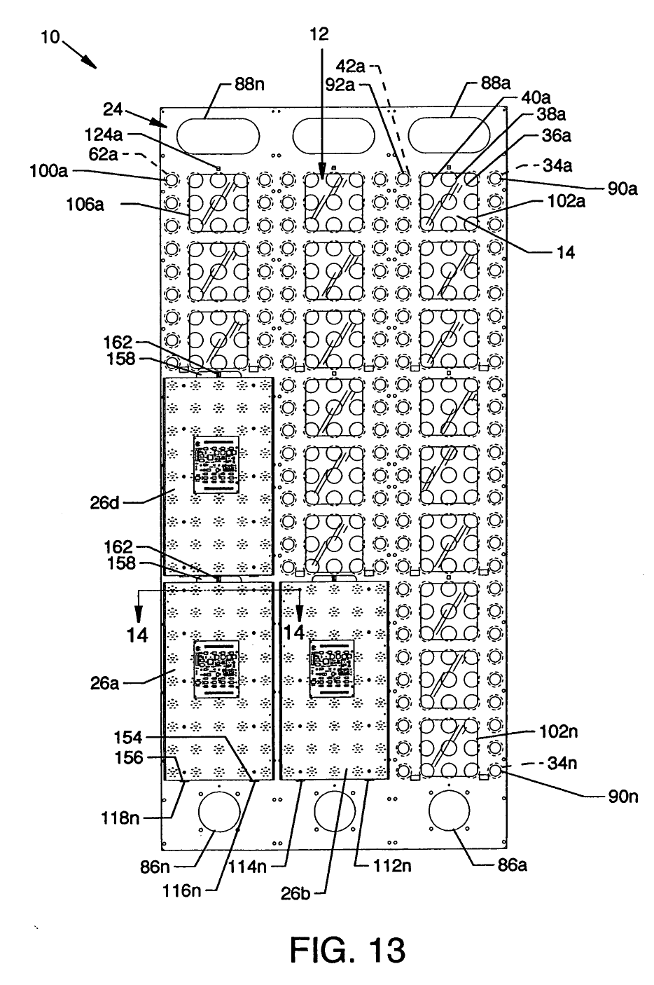

FIG. 13 is a rear view of the electronic display panel 10 with LED modules 26a, 26b and 26d installed at the rear panel 24. Also shown is the relationship of the circular openings 34a-34n . . . 62a-62n of the front panel 12 to both the circular openings 90a-90n, 92a-92n, 94a-94n, 96a-96n, 98a-98n and 100a-100n and the square openings 102a-102n, 104a-104n and 106a-106n of the rear panel 24 through which LEDs 172 of the LED modules 26a-26n are aligned for viewing in a manner described with reference to in FIG. 5. The use of square openings 102a-102n, 104a-104n and 106a-106n in the rear panel 24 provides for weight reduction and for access to the rear side of the polycarbonate panel 14 for the purposes of cleaning subsequent to removal of the one or more LED modules 26a-26n. For purposes of demonstration and example, access through the top square opening 102a would allow direct cleaning of the polycarbonate panel 14 located in near proximity to the top three circular openings of the circular openings 36a-36n, 38a-38n and 40a-40n. Access to the rear side of the polycarbonate panel 14 near the top three circular openings of circular openings 34a-34n and 42a-42n is also gained through the top square opening 102a and then laterally through the space between the front panel 12 and the rear panel 24.

FIG. 14 is a cross section view along line 14-14 of FIG. 13 showing the alignment of the LEDs 172 to the circular openings 144a . . . 152a of the insertion panel 28, to the circular openings 98s . . . 100s and square opening 106g, respectively, of the rear panel 24, and to the circular openings 54s . . . 62s of the front panel 12. Also shown is the alignment of the LED module 26a to the rear panel 24 and the alignment of the rear panel 24 to the front panel 12.

FIG. 15 is a fragmentary view in partial cross section of an LED module 26a during installation to the rear panel 24 which is shown in cross section. The front panel 12 is also shown in cross section where the cross section of the front panel 12 and the rear panel 24 is along line 15-15 of FIG. 12. The LED module 26a is first positioned at an angle in close proximity to the rear panel 24 and then maneuvered to introduce the offset tabs 154 and 156 into the tab receptors 116n and 118n, respectively. Maneuvering of the offset tab 154 in the tab receptor 116n is accomplished in the manner described with reference to FIG. 9 where the downwardly directed vertically oriented portion 154c is inserted into the tab receptor 116n at an angle and urged therethrough followed by further urging and maneuvering to introduce the angled portion 154b into the tab receptor 116n for alignment therein followed by pivoting of the LED module 26a, such as indicated by the arrow in FIG. 15, to complete capture of the offset tab 154 by the tab receptor 116n. Maneuvering of the offset tab 156 in the tab receptor 118n is accomplished simultaneously in similar manner.

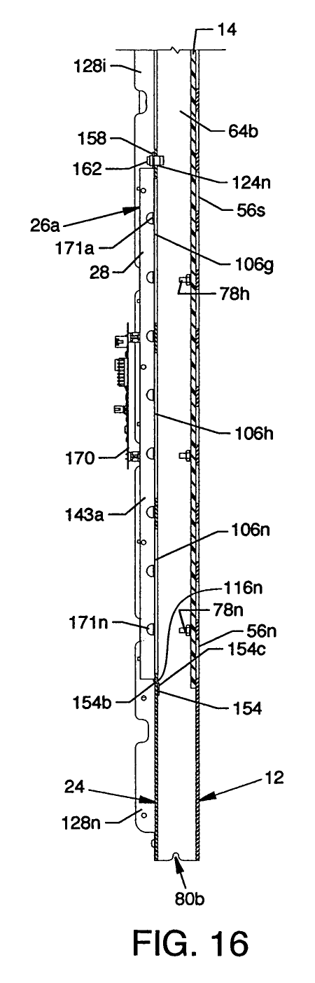

FIG. 16 is a view like FIG. 15 but shows the LED module 26a fully maneuvered and pivoted into intimate contact with the rearwardly facing surface of the rear panel 24. During such maneuvering and rotation, one end of the latch 162 is introduced into the latch receptor 124n and is subsequently and simply rotated such as by manual grasping and rotation or by engagement of a screwdriver or other suitable tool followed by rotation of the latch, which causes the latch 162 to lockingly engage the latch receptor 124n . Three-point attachment of the LED modules 26a-26n to the rear panel 24 is accomplished as described herein.

### Mode of Operation

An electronic display panel 10 can be installed into the frontal geometry of an electronic sign system as shown in patent application Ser. No. 11/148,461 entitled “Sign System” filed on Jun. 9, 2005. During an installation of the electronic display panel 10, the notches 80a, 80b and corresponding notches at the bottoms of the spacer bracket assemblies 20 and 22 pivotally engage an arcuate surface of a pivot bar and the top of the electronic display panel 10 is secured to the upper region of the frontal geometry of an electronic sign system. LED modules 26a-26n are secured to the rear panel 24 by the intimate engagement and securing of the offset tabs 154 and 156 with the rear panel 24 and engagement and securing of the latches 162 within the latch receptors 120a-120n, 122a-122n and 124a-124n. Disengagement is provided in the reverse order.

Various modifications can be made to the present invention without departing from the apparent scope hereof.

### ELECTRONIC DISPLAY PANEL

### Parts List

10 electronic display panel
12 front panel
14 polycarbonate panel
16 seal
18 spacer
20 spacer bracket assembly
20a-b spacer brackets
22 spacer bracket assembly
22a-b spacer brackets
24 rear panel
26a-n LED modules
28 insertion panel
30 LED display panel
32 apertured planar section
34a-n . . . 62a-n circular openings
64a-b edge panels
66a-b apertured flanges
68a-n studs
70a-n studs
72a-n studs
74a-n studs
76a-n studs
78a-n studs
80a-c notches
84 apertured planar section
88a-n inlet air openings
90a-n outlet air openings
92a-n circular openings
94a-n circular openings
96a-n circular openings
98a-n circular openings
100a-n circular openings
100a-n circular openings
102a-n square openings
104a-n square openings
106a-n square openings
108a-n tab receptors
110a-n tab receptors
112a-n tab receptors
114a-n tab receptors
116a-n tab receptors
118a-n tab receptors
120a-n latch receptors
122a-n latch receptors
124a-n latch receptors
126a-n apertured connection tabs
128a-n apertured connection tabs
130 panel
130a panel
132a-n arcuate recesses
132aa-nn arcuate recesses
134 panel
134a panel
136 panel
136a panel
138a-n holes
140a-n holes
142 apertured planar section
143a-b planar edge panels
144a-n . . . 152a-n circular openings
154 offset tab
154a vertically oriented portion
154b angled portion
154c downwardly directed vertically oriented
portion
156 offset tab
158 tab
160 latch mount hole
162 latch
164a-n studs
165a-n spacers
166a-n studs
167a-n spacers
170 electronics circuit board
17la-n cutouts
172 LED
173a-n cutouts
174 adhesive

1. An electronic display panel comprising:
a. a combination of aligned and connected forwardly located components and a plurality of rearwardly located LED (light emitting diode) modules easily and readily secured to the combination of aligned and connected forwardly located components;
b. major forwardly located components including, in order from front to back, a front panel, a seal, a polycarbonate panel, spacer brackets, and a rear panel and rearwardly located LED (light emitting diode) modules; and,
c. the rearwardly located LED modules including an insertion panel having offset tabs and an opposed latch which readily engage the rear panel of the forwardly located components in three-point attachment, whereby the geometry of the forwardly located components and the rearwardly located components is configured together or separately to offer minimum dimension structure where panels or edges of panels are mated and/or joined with such dimension minimalizing allows uniform spacing of the LED pixels across each of the adjacent LED modules, as well as across adjoining forwardly located components.

2. An electronic display panel comprising:
a. a forward combination of aligned and connected components having a rear panel; and,
b. a plurality of rearwardly located LED modules, each of the LED modules having a plurality of LEDs arranged thereon, each of the LED modules easily and readily secured to the rear panel of the forward combination of aligned and connected components, each of the LED modules including:
(1) an insertion panel having offset tabs; and,
(2) an opposed latch which readily engages the rear panel of the forward combination of aligned and connected components in three-point attachment.

3. The electronic display panel of claim 2, wherein the forward combination of aligned and connected components and the plurality of LED modules secured and attached thereto together are characterized by a geometry offering minimum dimension structure where panels or edges of panels are mated.

4. The electronic display panel of claim 2, wherein the forward combination of aligned and connected components includes, in order from front to back:
a. a front panel;
b. a seal;
c. a polycarbonate panel;
d. spacer brackets; and,
e. the rear panel.

5. The electronic display panel of claim 3, wherein the geometry allows uniform spacing of the LEDs across each of the adjacent LED modules of the plurality of LED modules.

6. The electronic display panel of claim 3, wherein the electronic display panel adjoins a like electronic display panel and wherein the geometry allows uniform spacing of the LEDs across the adjoining electronic display panels.

7. The electronic display panel of claim 6, wherein the LEDs appear as a seamless LED display presentation having uniform LED spacing when assembled with adjoining electronic display panels.

8. The electronic display panel of claim 3, wherein the spacer brackets are configured in a manner to offer mutual spaced support between the front and rear forwardly located panels and also are constructed for dimension minimalizing such that they will not interfere with the viewing of the LEDs of the LED modules of the plurality of LED modules.

9. The electronic display panel of claim 2, wherein the forward combination of aligned and connected components has a bottom edge and the forward combination of aligned and connected components further includes:
a. a plurality of notches located along the bottom edge for simple engagement of a pivot bar incorporated in a lower structure of a sign system.

10. The electronic display panel of claim 2, wherein the forward combination of aligned and connected components has an upper region and the forward combination of aligned and connected components further includes:
a. means suitable for accommodation by and for securing to an upper structure of a sign system.

11. The electronic display panel of claim 2, wherein the rear panel includes an apertured planar section.

12. The electronic display panel of claim 11, wherein the apertured planar section includes:
a. a plurality of inlet air openings arranged in a row at a bottom portion of the apertured planar section of the rear panel; and,
b. a plurality of outlet air openings arranged in a row at a top portion of the apertured planar section of the rear panel.

13. The electronic display panel of claim 12, wherein the inlet air openings and the outlet air openings communicate such that fan cooled or heating air may be past along and within the electronic display panel.

14. The electronic display panel of claim 4, wherein the rear panel includes columnar square openings.

15. The electronic display panel of claim 14, wherein each LED module aligns with three vertically aligned square openings of the columnar square openings.

16. The electronic display panel of claim 14, wherein each of the three vertically aligned square openings of the columnar square openings have rounded corners.

17. The electronic display panel of claim 16, wherein the front panel includes a plurality of spaced circular openings, each overlying and aligning with an LED of the LED modules, and wherein the rounded corners of the square openings of the rear panel have a radii slightly greater than the spaced circular openings of the front panel.

18. The electronic display panel of claim 15, further wherein the front panel includes a plurality of spaced circular openings, wherein nine spaced circular openings of the plurality of spaced circular openings of the front panel align with corresponding square openings of the columnar square openings of the rear panel.

19. The electronic display panel of claim 17, wherein the rear panel further includes circular openings between the columnar square openings.

20. The electronic display panel of claim 15, wherein the rear panel includes a pair of offset tab receptors for receiving offset tabs of each of the LED modules, which pair of tab receptors are situated adjacent a bottom edge of the lower square opening of the three vertically aligned square openings for each LED module.

21. The electronic display panel of claim 20, wherein the rear panel includes a latch receptor for receiving the opposed latch of each of the LED modules, which latch receptor is situated adjacent an upper edge of the upper square opening of the three vertically aligned square openings for each LED module.

22. The electronic display panel of claim 21, wherein the opposed latch of the LED module is actuated by rotary motion.

23. The electronic display panel of claim 22, wherein the opposed latch of the LED panel is engageable by a rotary hand tool.

24. The electronic display panel of claim 23, wherein the LED modules are installed by pivoting about paired offset tabs engaged in the tab receptors until the opposed latch contacts the latch receptor, then actuating the opposed latch with rotary motion through action of the rotary hand tool.

25. The electronic display panel of claim 23, wherein the LED panel is uninstalled by actuating the opposed latch to disengage from the latch receptor, then pivoting about offset tabs engaged in the tab receptors until the tabs may be separated from the tab receptors.

26. A method of providing an electronic display comprising the steps of:
a. providing an electronic display panel including:
(1) a forward combination of aligned and connected components having a rear panel; and,
(2) a plurality of rearwardly located LED modules, each of the LED modules having a plurality of LEDs arranged thereon, each of the LED modules easily and readily secured to the rear panel of the forward combination of aligned and connected components, each of the LED modules including:
(i) an insertion panel having offset tabs; and,
(ii) an opposed latch which readily engages the rear panel of the forward combination of aligned and connected components in three-point attachment;
b. installing the electronic display panel in a sign system; and,
c. powering selected LEDs of the LED module.

27. The method of claim 26, wherein the electronic display panel further includes notches at the bottom of the electronic display panel, and wherein the sign system includes a pivot bar having an arcuate surface for receiving the notches of the electronic display panel.

28. The method of claim 26, wherein the electronic display panel further includes an upper region and the electronic display panel is secured to the upper region subsequent to pivoting the notches on the arcuate surfaces of the pivot bar.

29. A method of maintaining an electronic display panel, the display panel having a forward combination of aligned and connected components having a rear panel and a plurality of rearwardly located LED modules, each of the LED modules having a plurality of LEDs arranged thereon, each of the LED modules easily and readily secured to the rear panel of the forward combination of aligned and connected components, each of the LED modules including an insertion panel having offset tabs and an opposed latch which readily engages the rear panel of the forward combination of aligned and connected components in a three-point attachment, the method comprising the steps of:
a. disengaging the three-point attachment by releasing the opposed latch and subsequently pivoting the insertion panel about the offset tabs to separate the LED module from the rear panel; and,
b. engaging an LED module to the rear panel by pivoting the insertion panel about the offset tabs to contact and then engage the opposed latch, and thereby establish the three-point attachment of the LED module to the rear panel.

30. The method of claim 29, wherein the LED module has been repaired between the steps of disengaging and engaging.

31. The method of claim 29, wherein the LED module engaged subsequent to the step of disengaging is a functional LED module.
